(19) United States
(12) Patent Application Publication
(10) Pub. No.: US 2025/0123733 A1
(43) Pub. Date: Apr. 17, 2025

(54) INTERACTIVE USER-INTERFACE ELEMENT OVERLAY

(71) Applicant: Consensus Sales, LLC, Atlanta, GA (US)

(72) Inventors: Brian Zurcher, St. George, UT (US); David Lindes, Salt Lake City, UT (US); Garin Hess, Saratoga Springs, UT (US); Mike Trionfo, Herriman, UT (US); Jeannie Laochaloenvanich, Pflugervile, TX (US); Cory Crouch, Taylorsville, UT (US); William Racule, Lehi, UT (US)

(21) Appl. No.: 18/916,546

(22) Filed: Oct. 15, 2024

Related U.S. Application Data
(60) Provisional application No. 63/589,904, filed on Oct. 12, 2023.

(51) Int. Cl. G06F 3/04845; G06F 9/451

(52) U.S. Cl. CPC G06F 3/04845; G06F 9/451

(57) ABSTRACT

A system may determine a first image for a demonstration presentation, which may include a plurality of pages that demonstrate the appearance and functionality of a digital product. For example, the image may include a screenshot of a website, computer application, or other digital product, and the system may set the first image as a background of a first page of the plurality of pages of the demonstration presentation. In some implementations, the system may determine a location on the first image for displaying one or more user interface (UI) elements. In some implementations, the system may store the demonstration presentation including the one or more UI elements on the first image in a computer-accessible data storage device and may provide the stored demonstration presentation including providing the first image and the one or more UI elements to an end user via a graphical user interface.

### BACKGROUND

This application relates to the creation and use of computer-based demonstrations. For example, technologies described in this application may allow administrative users to create demonstration presentations (“demos”), which may be customized within certain constraints by end users.

Currently, demos are created and are statically presented to users. Accordingly, users may be forced to sit through uninteresting features of a demo in order to receive information in which they are interested.

A demo of an application or computer program may include a limited set of the code of the website or computer application, which may be executed in a sandbox and may access, use, or copy code from the website or application. Unfortunately, creating a demo using code from an application or website is often a very cumbersome process that is easily broken as the code may change or may include bugs. Additionally, these active environments, such as where the code is copied or used in a sandbox, are complicated, may include numerous distractions (e.g., elements that are not being demonstrated), and tend to be very large files. Accordingly, while they are more engaging than a static image of a product, they create numerous technological issues, such as crashes, latency, bandwidth consumption, or increased programming time.

### SUMMARY

A system for generating and providing interactive demo presentations, for example, using UI elements overlayed on images can be configured to perform particular operations or actions by virtue of having software, firmware, hardware, or a combination of them installed on the system that in operation causes or cause the system to perform the actions. In some aspects, the techniques described herein relate to a computer-implemented method including: determining, by one or more processors, a first image for a demonstration presentation, the demonstration presentation including a plurality of pages demonstrating a digital product; setting, by the one or more processors, the first image as a background of a first page of the plurality of pages of the demonstration presentation; determining, by the one or more processors, a location on the first image for displaying one or more user interface (UI) elements; storing, by the one or more processors, the demonstration presentation including the one or more UI elements on the first image in a computer-accessible data storage device; and providing, by the one or more processors, the stored demonstration presentation including providing the first image and the one or more UI elements.

In some aspects, the techniques described herein relate to a computer-implemented method, further including: determining, by the one or more processors, a type of a first UI element selected from the group consisting of a checkmark, a hotspot, a button, and a text-input field; and determining, by the one or more processors, a first location relative to the first image for the first UI element of the determined type.

In some aspects, the techniques described herein relate to a computer-implemented method, further including: providing, by the one or more processors, a graphical user interface including a preview region showing the first image and a side panel showing a first representation of a first UI element; receiving, by the one or more processors, a user input dragging the first representation of the first UI element onto the first image in the preview region; and associating, by the one or more processors, the location to which the first representation was dragged with an overlayed location of the first UI element on the first image for the demonstration presentation.

In some aspects, the techniques described herein relate to a computer-implemented method, wherein: a first UI element of the one or more UI elements is overlayed over a defined location on the first image, the first UI element replicating a functionality of the digital product in the demonstration presentation.

In some aspects, the techniques described herein relate to a computer-implemented method, wherein: the first UI element includes a hyper-text transfer language (HTML) element overlayed over the first image, the first image being a static digital image, the HTML element providing the replicated functionality.

In some aspects, the techniques described herein relate to a computer-implemented method, wherein: providing access to the stored demonstration presentation includes receiving a user interaction with the first UI element and, responsive to the user interaction, displaying an informational popup, the informational popup showing information respective to the functionality of the digital product.

In some aspects, the techniques described herein relate to a computer-implemented method, wherein: providing the stored demonstration presentation includes providing a graphical user interface showing the plurality of pages with a plurality of UI elements, the plurality of UI elements being organized into a defined sequence of steps, the sequence of steps controlling when each of the plurality of UI elements and each of the plurality of pages are displayed on a client device.

In some aspects, the techniques described herein relate to a computer-implemented method, further including: determining, by the one or more processors, one or more attributes of the one or more UI elements, the one or more attributes including whether the one or more UI elements are displayed within a defined sequence of steps or displayed independently from the defined sequence of steps of the demonstration presentation.

In some aspects, the techniques described herein relate to a computer-implemented method, wherein: the demonstration presentation includes the plurality of pages demonstrating the digital product, each of the plurality of pages including an image as a background and a UI element, the UI elements of the plurality of pages being organized into a defined story path with a sequence of steps, an interaction with a first step causing the one or more processors to display a subsequent step in the sequence of steps, the first step and the subsequent step each including a UI element of the one or more UI elements.

In some aspects, the techniques described herein relate to a computer-implemented method, wherein: the first image includes a captured screenshot of a webpage, the webpage including functionality that is executable from the captured screenshot, the one or more UI elements replicating the functionality of the webpage in the demonstration presentation.

In some aspects, the techniques described herein relate to a system including: one or more processors; and a memory storing instructions that, when executed by the one or more processors, cause the system to perform operations including: determining a first image for a demonstration presentation, the demonstration presentation including a plurality of pages demonstrating a digital product; setting the first image as a background of a first page of the plurality of pages of the demonstration presentation; determining a location on the first image for displaying one or more user interface (UI) elements; storing the demonstration presentation including the one or more UI elements on the first image in a computer-accessible data storage device; and providing the stored demonstration presentation including providing the first image and the one or more UI elements.

In some aspects, the techniques described herein relate to a system, wherein the operations further include: determining a type of a first UI element selected from the group consisting of a checkmark, a hotspot, a button, and a text-input field; and determining a first location relative to the first image for the first UI element of the determined type.

In some aspects, the techniques described herein relate to a system, wherein the operations further include: providing a graphical user interface including a preview region showing the first image and a side panel showing a first representation of a first UI element; receiving a user input dragging the first representation of the first UI element onto the first image in the preview region; and associating the location to which the first representation was dragged with an overlayed location of the first UI element on the first image for the demonstration presentation.

In some aspects, the techniques described herein relate to a system, wherein: a first UI element of the one or more UI elements is overlayed over a defined location on the first image, the first UI element replicating a functionality of the digital product in the demonstration presentation.

In some aspects, the techniques described herein relate to a system, wherein: the first UI element includes a hyper-text transfer language (HTML) element overlayed over the first image, the first image being a static digital image, the HTML element providing the replicated functionality.

In some aspects, the techniques described herein relate to a system, wherein: providing access to the stored demonstration presentation includes receiving a user interaction with the first UI element and, responsive to the user interaction, displaying an informational popup, the informational popup showing information respective to the functionality of the digital product.

In some aspects, the techniques described herein relate to a system, wherein: providing the stored demonstration presentation includes providing a graphical user interface showing the plurality of pages with a plurality of UI elements, the plurality of UI elements being organized into a defined sequence of steps, the sequence of steps controlling when each of the plurality of UI elements and each of the plurality of pages are displayed on a client device.

In some aspects, the techniques described herein relate to a system, wherein the operations further include: determining one or more attributes of the one or more UI elements, the one or more attributes including whether the one or more UI elements are displayed within a defined sequence of steps or displayed independently from the defined sequence of steps of the demonstration presentation.

In some aspects, the techniques described herein relate to a system, wherein: the demonstration presentation includes the plurality of pages demonstrating the digital product, each of the plurality of pages including an image as a background and a UI element, the UI elements of the plurality of pages being organized into a defined story path with a sequence of steps, an interaction with a first step causing the one or more processors to display a subsequent step in the sequence of steps, the first step and the subsequent step each including a UI element of the one or more UI elements.

In some aspects, the techniques described herein relate to a system, wherein: the first image includes a captured screenshot of a webpage, the webpage including functionality that is executable from the captured screenshot, the one or more UI elements replicating the functionality of the webpage in the demonstration presentation.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for providing interactive user-interface element overlays, for example, over images in a demonstration presentation or demo tour.

FIG. 2 is a block diagram of an example computing system.

FIG. 3 illustrates a flowchart of an example method for creating and using a digital demonstration presentation, as described elsewhere herein.

FIGS. 4A and 4B illustrate example graphical user interfaces in which example demonstration presentations are displayed.

FIGS. 5A-5G illustrate example graphical user interfaces displayed by a demo application for adding and configuring live UI elements, for example, over background images.

FIGS. 6A and 6B illustrate example graphical user interfaces in which a story path is graphically represented and the position of a live UI element in the story path is defined.

FIGS. 7A-7E illustrate example graphical user interfaces in which a demonstration presentation is displayed to a user.

### DESCRIPTION

The present disclosure relates to systems and methods for an interactive user-interface element overlay, for example, over an image in a demonstration presentation.

Implementations of the technology provide a system for building a customized demo by a stakeholder, such as an administrator, salesperson, educator, or other user.

Some historical demonstration presentations were merely a set of images with graphics or text explaining the product, program, website, etc. Unfortunately, these static demonstrations failed to engage users, were not dynamic, and did not provide feedback to their creators (e.g., of user engagement, completion, etc.).

As described above, while it may provide functionality of a website or application, because copying code from a website or application may require substantial additional programming, it is less useful for many users who are not adept at programming. Accordingly, a programmer may be required to stand up or debug the content.

For example, a computer system or program generating a demonstration presentation allowing interaction with a website may copy the DOM (document object model) or other HTML of the website to create a mirror or sandboxed copy of the website. This copy of the website may be used in the demonstration; however, as noted above, copying the code or model often results in errors or other issues. Similarly, each time something (e.g., code, a graphical element, a layout, a link, etc.) is changed in the original or in the copy, the demonstration presentation may cease to operate properly.

Accordingly, in order to improve and to address the issues of the background while retaining the interactability, the technology described herein provides numerous operations, features, and advantages.

In some implementations, the technology may include using one or more static images to create a demonstration; and, in order to allow the demo to simulate interaction with specific portions of a product, such as a digital product. A digital product, for instance, may include an application or website (it should be noted that other types of content are possible and contemplated herein), the technology may use live user interface elements, which may be overlayed over and linked to the image(s). For example, an HTML element (e.g., an object or box) may be placed over a screenshot to provide or replicate limited functionality of the product being demoed as a type of façade that does not use the real product but provides the look and feel of the product with limited functionality. Additionally, because the live UI element overlays may be defined by a creator/administrator, the images, overlays, and other elements of the demonstration presentation may be created with a defined flow and/or logic that requires and tracks user engagement, which may not be possible by copying website or application code. For instance, these elements may be organized into a story that provides an engaging demonstration that uses defined elements of the original website/application (e.g., potentially less than all functionality or features).

Accordingly, in some implementations, the technology may allow users to interact with certain functions of an application or website in a narrow, defined way without granting them access to the application/website itself (which may have security and other implications) or creating and maintaining a sandbox environment. The demo versions of the application/website, using the technology, may be sanitized and unlikely to break during the demonstration presentation.

Implementations of the technology provide a system for creating a customizable demo that can easily be customized by a user. The customizable demo may be organized to provide an interactive story path in a way that is customizable by an end user but retains the narrative originally created by the administrator.

The technology described herein may allow the images and live UI elements to be organized into a story(ies) or path(es) of steps where images are shown in sequence, UI elements are overlayed in sequence, and the user may step through the sequence. Each step may include media or interactable (e.g., live UI elements, highlighting, hotspots, etc.) graphical or other (e.g., audio, etc.) elements that explain (e.g., through text, audio, video, an interaction, or otherwise) an associated aspect of an image representing the original application, website, or other content. The story path may include logic that determines when the user is allowed to move on to the next step, such as based on a certain interaction, time period, input, or otherwise. Accordingly, an administrator may use the technology to create a demonstration presentation that creates engagement and understanding. Similarly, the technology may track user interaction with each step in the story path to determine user engagement (e.g., completion, time elapsed, accuracy, etc.), and may allow an administrator to view the engagement analytics.

In addition to the story path defining a sequence of engagement/information elements, the technology may allow a guided freedom experience in which an administrator may add elements to a page or image of a demonstration application that are outside of the sequence/story path. Accordingly, at certain points or in general, an end user using the generated demonstration presentation may interact with these elements outside of/separate from the sequence. The technology may track user interaction with the elements linked to the story path or independent therefrom, so that a user (and, potentially, an administrator on a backend system) may track their progress through the sequence. In some instances, the technology may allow the user to skip steps until the furthest step previously reached. In some instances, the technology may change the color or other graphical appearance of graphical UI elements representing the steps to indicate that the step or independent element has already been viewed/interacted with. Accordingly, this UI element overlay technology allows both a guided experience and allows end user freedom to delve into additional details or depth of an element, page, or other demonstration presentation object (e.g., page, image, media object, UI element, etc.).

With reference to the figures, reference numbers may be used to refer to example components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

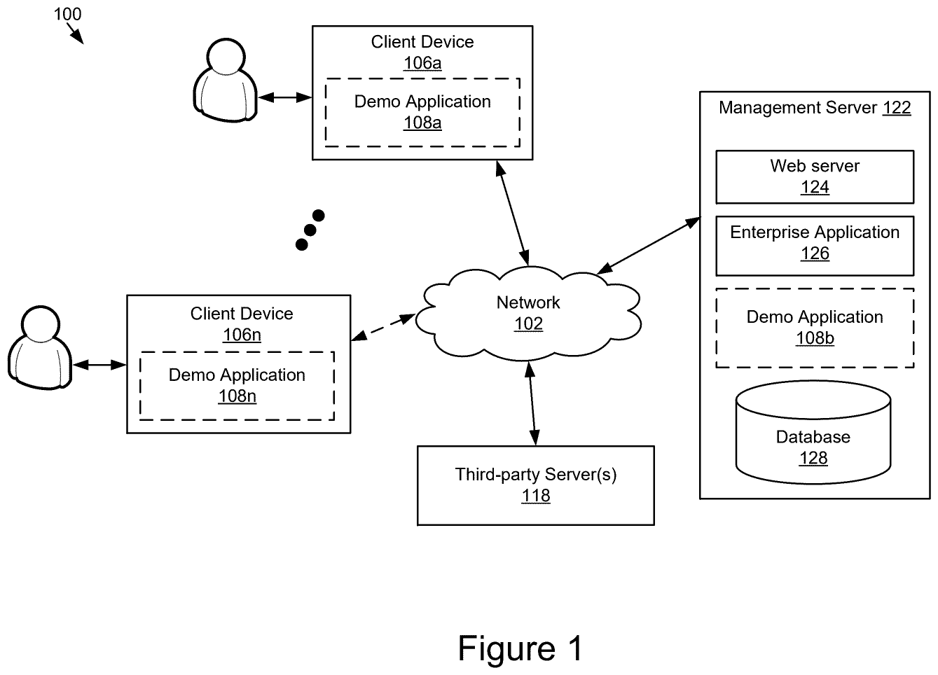

FIG. 1 is a block diagram of an example system 100 for providing interactive user-interface element overlays, for example, over images in a demonstration presentation or demo tour. The demo tours may also include layered information previewed in customizable cards and multi-layered information in hot spots or other UI elements on a graphical interface. The illustrated system 100 may include one or more client devices 106, a third-party server 118, and/or a management server 122, which may run instances of the demo application 108a, 108b . . . 108n and which may be electronically communicatively coupled via a network 102 for interaction with one another, although other system configurations are possible including other devices, systems, and networks. For example, the system 100 could include any number of client devices 106, third-party servers 118, management server(s) 122, and other systems and devices.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client device(s) 106 (e.g., multiple client devices 106 may be used by a single participant, multiple participants, stakeholders, administrators, or by other users) includes one or more computing devices having data processing and communication capabilities. The client device 106 may couple to and communicate with other client devices 106 and the other entities of the system 100 via the network 102 using a wireless and/or wired connection, such as the management server 122. Examples of client devices 106 may include, but are not limited to, mobile phones, wearables, tablets, laptops, desktops, netbooks, server appliances, servers, virtual machines, televisions, extended reality headsets, etc. The system 100 may include any number of client devices 106, including client devices 106 of the same or different type.

In some implementations, one or multiple client devices 106 may be used with a demo application 108 to execute an instance or component thereof or to otherwise access the demo application 108, for example, via the web server 124.

The management server 122 and its components may aggregate information about and provide data associated with the systems and processes described herein to a multiplicity of users on a multiplicity of client devices 106, for example, as described in reference to various users and client devices 106 described herein. In some implementations, a single user may use more than one client device 106a . . . 106n, which the management server 122 as described above, or multiple users may use multiple client devices 106a . . . 106n to interact with to perform operations described herein. In some implementations, the management server 122 may communicate with and provide information to a client device 106.

The management server 122 may include a web server 124, an enterprise application 126, a demo application 108, and/or a database 128. In some configurations, the enterprise application 126 and/or demo application 108 may be distributed over the network 102 on disparate devices in disparate locations or may reside in the same location. The client device 106a and/or the management server 122 may each include an instance of the demo application 108 and/or portions/functionalities thereof. The client devices 106 may also store and/or operate other software such as a demo application 108, an operating system, other applications, etc., that are configured to interact with the management server 122 via the network 102.

The management server 122 and/or the third-party server 118 have data processing, storing, and communication capabilities, as discussed elsewhere herein. For example, the servers 118 and/or 122 may include one or more hardware servers, server arrays, storage devices and/or systems, etc. In some implementations, the servers 118 and/or 122 may include one or more virtual servers, which operate in a host server environment.

In some implementations, the enterprise application 126 may receive communications from a client device 106 in order to perform the functionality described herein. The enterprise application 126 may receive information and provide information to the demo application 108 to generate adaptable graphical interfaces described, as well as perform and provide analytics and other operations. In some implementations, the enterprise application 126 may perform additional operations and communications based on the information received from client devices 106, as described elsewhere herein.

The database 128 may be stored on one or more information sources for storing and providing access to data, such as the data storage device 208. The database 128 may store data describing client devices 106, instances of the demo application 108, media segments, images, UI elements, composite data files, metadata, preferences, configurations, and other information, such as described herein.

A third-party server 118 can host services such as a third-party application (not shown), which may be individual and/or incorporated into the services provided by the management server 122. For example, the third-party server 118 may represent one or more item databases, forums, company websites, etc. For instance, a third-party server 118 may provide automatically delivered and processed data, such as frames, attributes, media segments, and/or services, such as media processing services or other services.

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

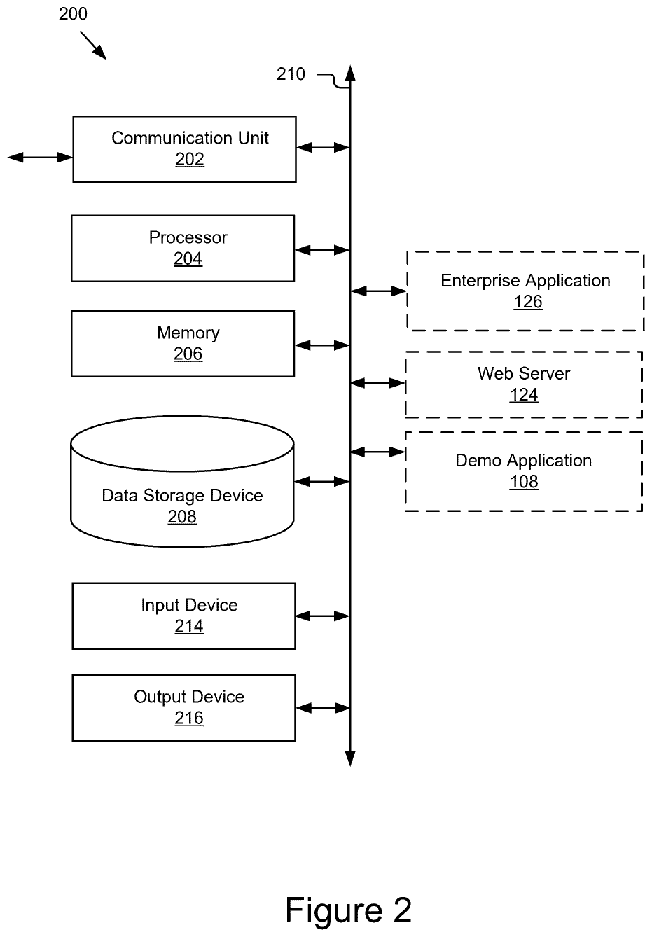

FIG. 2 is a block diagram of an example computing system 200, which may represent computer architecture of a client device 106, third-party server 118, management server 122, and/or another device described herein, depending on the implementation. In some implementations, as depicted in FIG. 2, the computing system 200 may include an enterprise application 126, a web server 124, a demo application 108, or another application, depending on the configuration. For instance, a client device 106 may include or execute a demo application 108 (which could incorporate various aspects of the enterprise application 126, in some implementations); and the management server 122 may include the web server 124, the enterprise application 126, and/or components thereof, although other configurations are also possible and contemplated.

The enterprise application 126 includes computer logic executable by the processor 204 to perform operations discussed elsewhere herein. The enterprise application 126 may be coupled to the data storage device 208 to store, retrieve, and/or manipulate data stored therein and may be coupled to the web server 124, the demo application 108, and/or other components of the system 100 to exchange information therewith.

The web server 124 includes computer logic executable by the processor 204 to process content requests (e.g., to or from a client device 106). The web server 124 may include an HTTP server, a REST (representational state transfer) service, or other suitable server type. The web server 124 may receive content requests (e.g., product search requests, HTTP requests) from client devices 106, cooperate with the enterprise application 126 to determine the content, retrieve and incorporate data from the data storage device 208, format the content, and provide the content to the client devices 106.

In some instances, the web server 124 may format the content using a web language and provide the content to a corresponding demo application 108 for processing and/or rendering to the user for display. The web server 124 may be coupled to the data storage device 208 to store retrieve, and/or manipulate data stored therein and may be coupled to the enterprise application 126 to facilitate its operations.

The demo application 108 includes computer logic executable by the processor 204 on a client device 106 to provide for user interaction, receive user input, present information to the user via a display, and send data to and receive data from the other entities of the system 100 via the network 102. In some implementations, the demo application 108 may generate and present user interfaces based on information received from the enterprise application 126, third-party server 118, and/or the web server 124 via the network 102. For example, a stakeholder/user may use the demo application 108 to perform the operations described herein.

As depicted, the computing system 200 may include a processor 204, a memory 206, a communication unit 202, an output device 216, an input device 214, and a data storage device 208, which may be communicatively coupled by a communication bus 210. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations. The processor 204, memory 206, communication unit 202, etc., are representative of one or more of these components.

The processor 204 may execute software instructions by performing various input, logical, and/or mathematical operations. The processor 204 may have various computing architectures to method data signals (e.g., CISC, RISC, etc.). The processor 204 may be physical and/or virtual and may include a single core or plurality of processing units and/or cores. In some implementations, the processor 204 may be coupled to the memory 206 via the bus 210 to access data and instructions therefrom and store data therein. The bus 210 may couple the processor 204 to the other components of the computing system 200 including, for example, the memory 206, the communication unit 202, the input device 214, the output device 216, and the data storage device 208.

The memory 206 may store and provide access to data to the other components of the computing system 200. The memory 206 may be included in a single computing device or a plurality of computing devices. In some implementations, the memory 206 may store instructions and/or data that may be executed by the processor 204. For example, the memory 206 may store one or more of the enterprise application 126, the web server 124, the demo application 108, and their respective components, depending on the configuration. The memory 206 is also capable of storing other instructions and data, including, for example, an operating system, hardware drivers, other software applications, databases, etc. The memory 206 may be coupled to the bus 210 for communication with the processor 204 and the other components of computing system 200.

The memory 206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 204. In some implementations, the memory 206 may include one or more of volatile memory and non-volatile memory (e.g., RAM, ROM, hard disk, optical disk, etc.). It should be understood that the memory 206 may be a single device or may include multiple types of devices and configurations.

The bus 210 can include a communication bus for transferring data between components of a computing device or between computing devices, a network bus system including the network 102 or portions thereof, a processor mesh, a combination thereof, etc. In some implementations, the enterprise application 126, web server 124, demo application 108, and various other components operating on the computing system/device 200 (operating systems, device drivers, etc.) may cooperate and communicate via a communication mechanism included in or implemented in association with the bus 210. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 202 may include one or more interface devices (I/F) for wired and wireless connectivity among the components of the system 100. For instance, the communication unit 202 may include, but is not limited to, various types known connectivity and interface options. The communication unit 202 may be coupled to the other components of the computing system 200 via the bus 210. The communication unit 202 can provide other connections to the network 102 and to other entities of the system 100 using various standard communication protocols.

The input device 214 may include any device for inputting information into the computing system 200. In some implementations, the input device 214 may include one or more peripheral devices. For example, the input device 214 may include a keyboard, a pointing device, microphone, an image/video capture device (e.g., camera), a touchscreen display integrated with the output device 216, etc. The output device 216 may be any device capable of outputting information from the computing system 200. The output device 216 may include one or more of a display (LCD, OLED, etc.), a printer, a haptic device, audio reproduction device, touch-screen display, a remote computing device, etc. In some implementations, the output device is a display which may display electronic images and data output by a processor of the computing system 200 for presentation to a user, such as the processor 204 or another dedicated processor.

The data storage device 208 may include one or more information sources for storing and providing access to data. In some implementations, the data storage device 208 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data storage device 208 may be organized and queried using various criteria including any type of data stored by them, such as described herein. For example, the data storage device 208 may store the database 128. The data storage device 208 may include data tables, databases, or other organized collections of data. Examples of the types of data stored by the data storage device 208 may include, but are not limited to, the data described with respect to the figures, for example, the data may include user accounts, media segments, images, demonstration presentations, UI elements, media, topic data, topic cards, administrative roles, user roles, etc.

The data storage device 208 may be included in the computing system 200 or in another computing system and/or storage system distinct from but coupled to or accessible by the computing system 200. The data storage device 208 can include one or more non-transitory computer-readable mediums for storing the data. In some implementations, the data storage device 208 may be incorporated with the memory 206 or may be distinct therefrom.

The components of the computing system 200 may be communicatively coupled by the bus 210 and/or the processor 204 to one another and/or the other components of the computing system 200. In some implementations, the components may include computer logic (e.g., software logic, hardware logic, etc.) executable by the processor 204 to provide their acts and/or functionality. In any of the foregoing implementations, the components may be adapted for cooperation and communication with the processor 204 and the other components of the computing system 200.

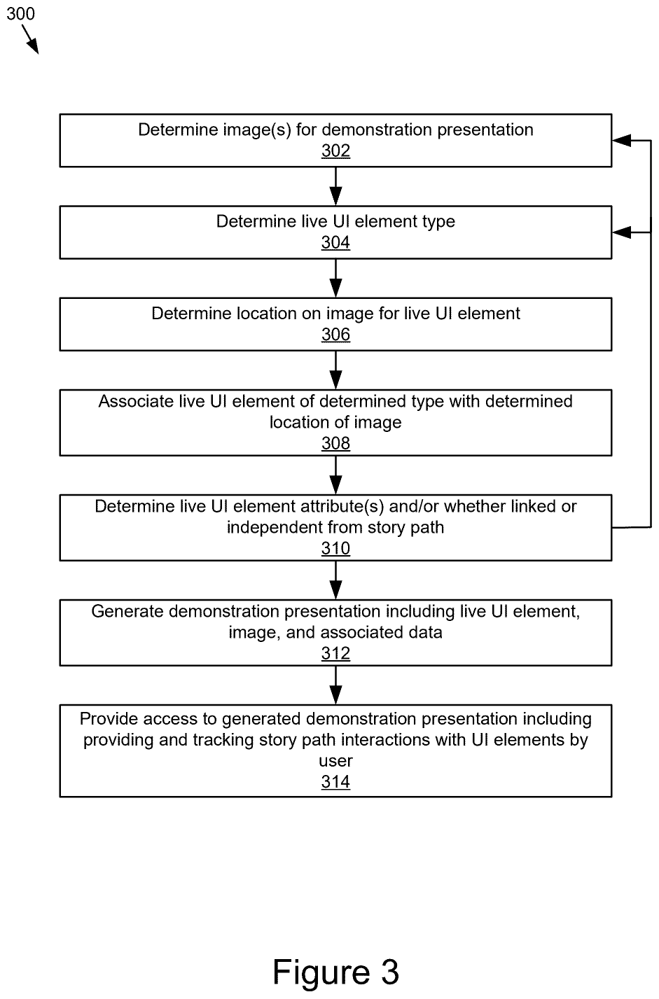

FIG. 3 illustrates a flowchart of an example method 300, which provides operations for creating and using a digital demonstration presentation, as described elsewhere herein. The operations may be used in addition to or alternative from the others described herein, such as those described above or in reference to the example graphical user interfaces illustrated and described herein. It should be noted that, although certain operations are described, the specific operations may be augmented, removed, reordered, or otherwise modified without departing from the scope of this disclosure.

At 302, the demo application 108 may determine one or more images for a digital demonstration presentation (also referred to herein as a demonstration presentation or demo). For example, the demo application 108 may receive inputs from a user defining topics, types, layouts, or other details of the demo. The demo application 108 may receive uploaded images, such as screenshots/screen grabs of a website or computer application being demoed. For example, a user or the demo application 108 may capture a screenshot of a webpage for which a demonstration is being prepared using the demo application 108 or may upload or open the image in the demo application 108.

In some implementations, the image(s) may be ordered into a sequence and/or set of topics based on user input and/or based on a sequence of which they are input into the demo application 108 for the demo, as illustrated elsewhere herein.

At 304, the demo application 108 may determine a type for a live (e.g., changing and/or interactive) UI element associated with a page or image of the demonstration presentation. For example, the user may provide inputs into a graphical user interface that define one or more various UI elements that may be overlayed onto an image. For instance, a graphical element may include a hotspot, which may be represented by a graphical circle, checkmark, arrow, bounding box, etc., while defining the UI elements and/or during use of the demo by an end user (e.g., when selected, hovered over, or displayed in a story). For instance, a hotspot may be hovered over or selected to display an information field, such as a text box or media (e.g., a video, audio, etc.) segment. In some implementations, a hotspot may blink, be highlighted, change colors, change shapes, or otherwise be differentiated from the remainder of the background image.

In some implementations, a type for the UI element may be one or various types of interactable live UI elements that detect and use a user interaction. The demo application 108 may use the user interaction to update the graphical display of the live UI element, increment a step through a story path, or perform other operations. For instance, an interactable live UI element may include a text input box, checkmark box, button, drop-down menu, radio button, hover-over element, or other graphical element. As described below, the appearance, resulting behavior, story-path behavior (e.g., where or whether it is linked to an order of a story path or independent therefrom), and/or other attributes of the live UI element may be defined in advance or after it is placed. It should be noted that although some example UI elements are provided, others are possible and contemplated.

In some implementations, the live UI element may be defined, stored, or represented as HTML or other code that is associated with the image.

In some implementations, the demo application 108 may receive a user input selecting the UI element type via graphical user interface, although other implementations are possible. For instance, a demo application 108 may automatically select a type of live UI elements and/or the attributes thereof based on image analysis of an image, based on an analysis of the DOM of a website being demoed, or based on other automated processes. For example, a demo application 108 may detect a rectangular element of an image with text in it and automatically suggest to a user that a live UI element be overlayed thereon allowing a demo of text entry. Other automated processes are possible and contemplated herein.

At 306, the demo application 108 may determine a location (whether before or after its type or other attributes are defined) on an image for the live UI element or script. The location may be a point location relative to/on the image or demo page (e.g., a pixel thereof) or it may be a boundary box or other shape.

For example, the location may be based on one or more X-Y coordinates relative to a two-dimensional image (e.g., the received/determined image), although other methods of defining its location may be used. For example, an administrator may select a location on an image or demo page and the demo application 108 may determine the location and associate it with a graphical element associated with the UI element type. In some instances, as noted above, the demo application 108 may detect certain common shapes on an image and recommend a location. For example, the demo application 108 may automatically detect a rectangular text input box on an image and select the location, thereby allowing it to be easily overlayed with a live UI element, for example, after an administrator confirms that they wish to place a live UI element at the suggested location. Automated detection and suggestion of other UI elements is also possible.

For instance, the image may include a screenshot of a webpage where the webpage included a button, text-input field, etc. The administrative user may provide input to the demo application 108 to select a live UI element type that is a text-field box and drag a boundary of a box on the graphical interface to match that of the text-input field that was on the original webpage represented by the image/screenshot.

At 308, the demo application 108 may associate the live UI element of the determined type with the determined location of the image. For instance, in an HTML entry (or data field, metadata, file, etc., depending on the implementation) for the image or demo page, the demo application 108 may associate the live UI element with the defined X-Y coordinates.

At 310, the demo application 108 may determine one or more attributes of the live UI element and/or whether the live UI element is linked to or independent from a story path of the demonstration presentation. The attribute(s) may have defaults depending on the UI element type, such as a text-input field may be defined to receive text and determine whether the text satisfies a condition. The attribute(s) may additionally or alternatively be automatically or manually defined. For instance, a user may define a color, condition, action, or other detail of a box for a text-input field. Example UI elements and attributes are also illustrated and described in reference to example graphical user interfaces herein.

Although numerous other implementations are possible and contemplated herein, the attribute(s) may include an appearance of a UI element, a condition for the UI element (e.g., whether it receives user interaction via a hover-over by a cursor, any text input, a defined text input, a selection, etc.), or an action (e.g., that the appearance of the UI element changes, another UI element, media, or graphic is displayed, text is entered/received, a next step in a story path is allowed or displayed, or another action).

Depending on the implementation, the appearance attribute may indicate a box size, background, color, animation, movement, transition, font, etc.; the condition attribute may indicate a specific user interaction that causes an action such as a click, text entry, drag, hover-over, previous step in a story path, etc.; and the action element may indicate an action taken in response to satisfaction of the condition, such as displaying a checkmark, displaying text, moving through a story path sequence, displaying a video, changing an appearance of the UI element, displaying a drop down, etc. The UI element may be nested or have additional layers of interaction, such as where selection of a live UI element button displays a drop-down menu, which may then receive further input and provide additional conditions/actions. For example, a live UI element may only appear or be activated based on interaction with a separate live UI element.

As an example, where the image includes a screenshot of a webpage with a text-entry field, the demo application 108 may receive user inputs from an administrator building a digital demonstration presentation that define an HTML text-entry field linked to a defined location on the image. For example, the administrator may define a text-entry field that is overlayed over the top of the original field in the image, so that an end user, executing the demo, would see the UI element instead of (e.g., replacing, overlayed over, hiding) the portion of the image corresponding to the original text-entry field of the website. In other instances, the UI element may be overlayed over the area of the image (e.g., of the text entry field), but it may be transparent or hidden until the user interacts with it (e.g., opaque text may be added at the live UI element).

In some implementations, the attribute(s) may define whether the UI element is linked to a story path or is independent. For example, a UI element may automatically be added to a sequence of steps through which an end user would step through when executing the digital demo. The position at which the UI element is linked may define at what point it is displayed in the sequence and may be automatically determined based on when it is added to the demonstration presentation or added to the image/demo page. A user may redefine the position of the UI element in the sequence by dragging it across a list of story path steps or otherwise modifying its attributes or logic. For example, an action of a live UI element may include displaying a “next step” option (e.g., selectable to display a next or previous step) or the next step in a sequence when a condition (e.g., entering specific text in a text field or pressing a button) for the UI element is completed by the user.

In some implementations, the administrative user defining the UI element's attributes may include whether the UI element is independent from the story path/sequence of demo steps. For example, when the demo is displayed to an end user (e.g., when the end user is viewing a page corresponding to the image to which the independent UI element is associated), the user may interact with the independent UI element separately from the story path sequence. For example, the progression of the digital demonstration presentation may pause or stop in response to the demo application 108 receiving an interaction with an independent UI element. The demo application 108 may record which steps and/or UI elements with which the user has interacted and use it to provide analytics to an administrator or other stakeholder and/or allow the end user to re-commence the story path.

In some implementations, the operations of the example method 300 may be recursively repeated until no additional UI elements are defined and/or no additional images or demo pages are added to the digital demonstration presentation. For instance, a sequence of images or pages, each of which may have associated a sequence or set of UI elements, may be added to create a story that demonstrates the features of an application, website, or other contents, or otherwise provides education or tests interaction therewith.

At 312, the demo application 108 may generate and/or store the generated demonstration presentation including the live UI element(s), image(s), and associated data in a computer database.

At 314, the demo application 108 may provide access to the generated demonstration presentation including providing and tracking story path interactions with images and/or live UI elements by a user. For example, an administrative user may send a file containing the digital demonstration presentation or may provide access to an end user (e.g., by associating the demo with the user's account, providing a link, etc.). The demo application 108 or associated application may display the images and defined UI elements to the user in sequence and/or out of sequence (e.g., for independent UI elements). Accordingly, the image of a utility being demonstrated may be provided with created live UI elements (e.g., HTML objects) that allow the appearance of limited interactions with the image, which, in turn, illustrates the look and feel of the original utility, although there may be no link thereto or code therefrom.

In some implementations, the demo presentation may be presented, accessed, viewed, interacted with, or otherwise on a website via a web server (e.g., hosted on a management server 122 or third-party server 118). For example, the demo presentation may be built and/or accessed via a web browser which may locally execute portions of the code or access functionality and/or content provided by a remote server, such as the management server 122.

In some implementations, the demo application 108 or another application may track the user's interactions and provide associated analytics to the user, to the administrator, or to another stakeholder.

Various features and operations described above may also be described and/or represented in the example graphical user interfaces below.

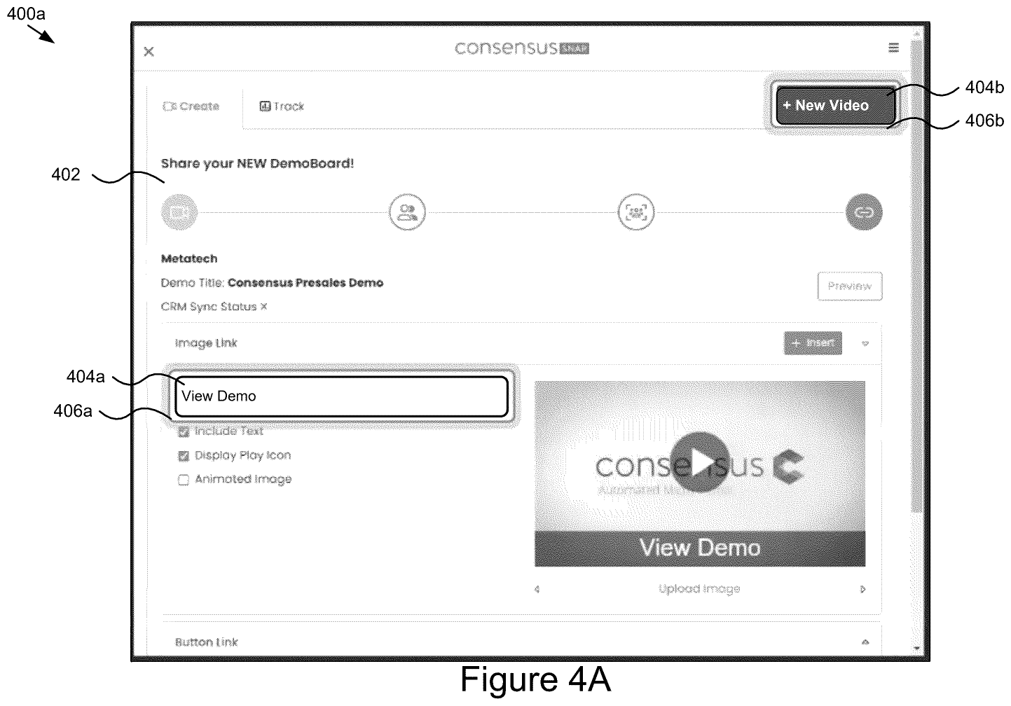

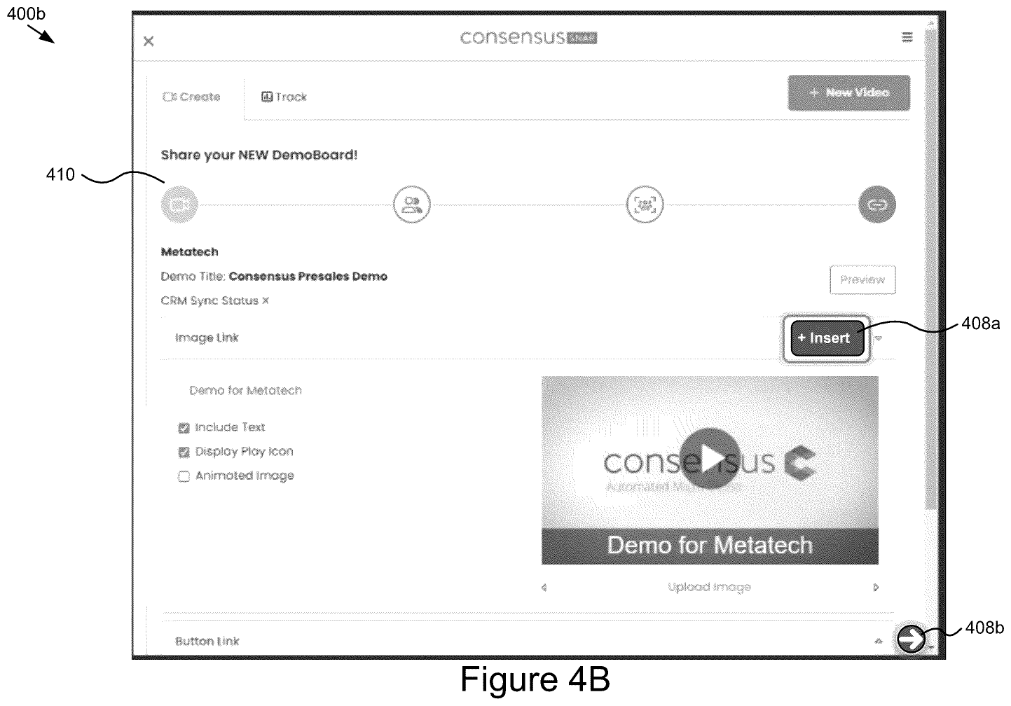

FIG. 4A illustrates an example graphical user interface 400a in which a demonstration presentation (showing a demo of the demo application 108) is displayed. In the depicted example, a background image 402 is displayed, which image may include various graphics, text, lines. As illustrated, two UI elements 404a and 404b (at the New Video and View Demo buttons) are shown highlighted by bounding boxes 406a and 406b, respectively. The UI elements may be highlighted during configuration and/or use of the demo, for example, by bounding boxes or other graphical elements. In some implementations the bounding boxes 406a and 406b may be animated to change intensity, grow/shrink, or otherwise to further draw attention to them. For example, the View Demo UI element 404a may be selected to show and/or select a demo.

These UI elements may be overlayed over the image 402 as a background, so that the appearance is consistent with the captured page, window, application, etc., but so that a user may interact with the UI elements. As noted in further detail below, a UI element may be overlayed on the image and defined to perform actions, which may correspond to elements of the captured page. The live UI elements may be manually defined by a user after having captured an image of a page, although other implementations and automations are possible.

As noted above, an administrative user may select the background image 402 and then define the UI elements 404a and 404b and/or the bounding boxes 406a and 406b, which may be overlayed over the image and viewed by an end user. In some instances, the UI elements 404 may be selectable to display information frames, media, or to navigate through the demo presentation, for example, to navigate through to other page(s). For instance, the View Demo element 404a may display a different page. The New Video element 404b may be selectable and, in response, may display an information region, such as an iframe, popup, or other element displaying information about uploading a new video. It should be noted that the example demo in FIG. 4A is a demo of a utility for creating a demo presentation.

FIG. 4B illustrates an example graphical user interface 400b, similar to the example interface 400a, in which two more UI elements 408a and 408b are shown including an Insert button and an arrow to move to the next screen. The interface 400b may represent a second page in a demo presentation, which may include an image 410 with UI elements 408 overlayed thereon. For example, the interface 400b in FIG. 4B may be shown in response to previous UI elements (e.g., 404a in FIG. 4A) being interacted with to step through a story path. For example, one of the live UI elements 408a or 408b, when selected by a user, may cause a subsequent screen/image/page, UI element, or otherwise, to be shown in the demo presentation.

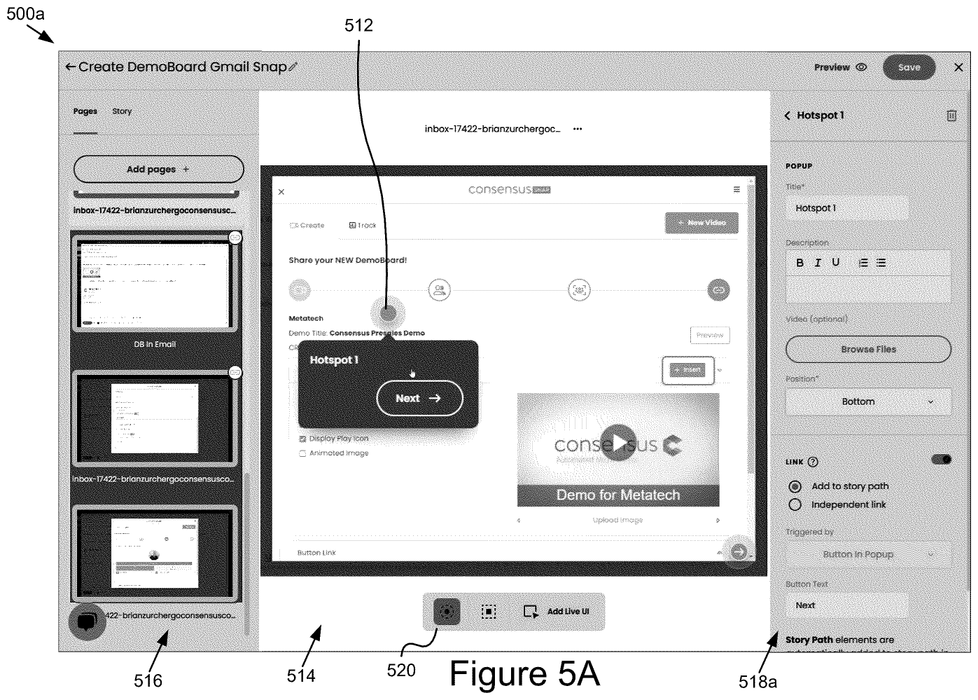

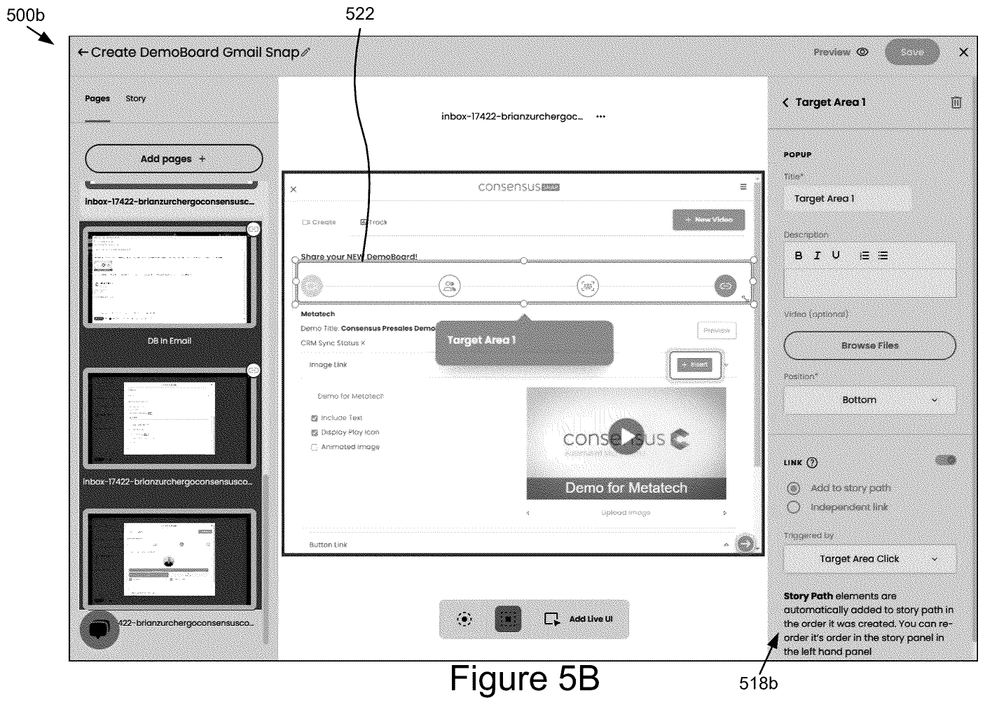

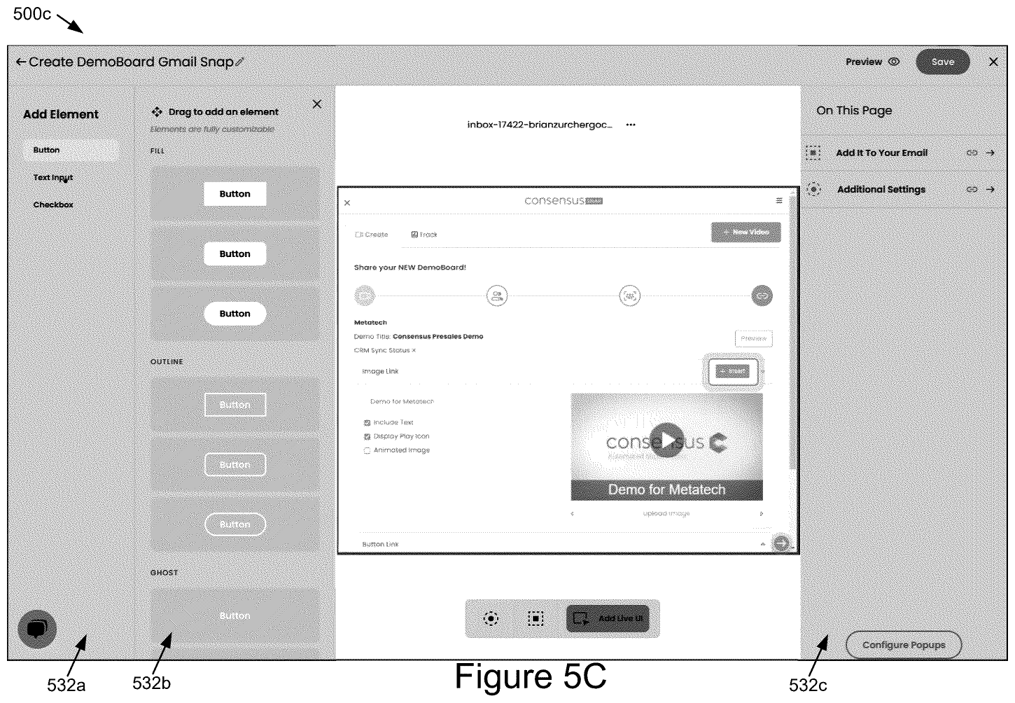

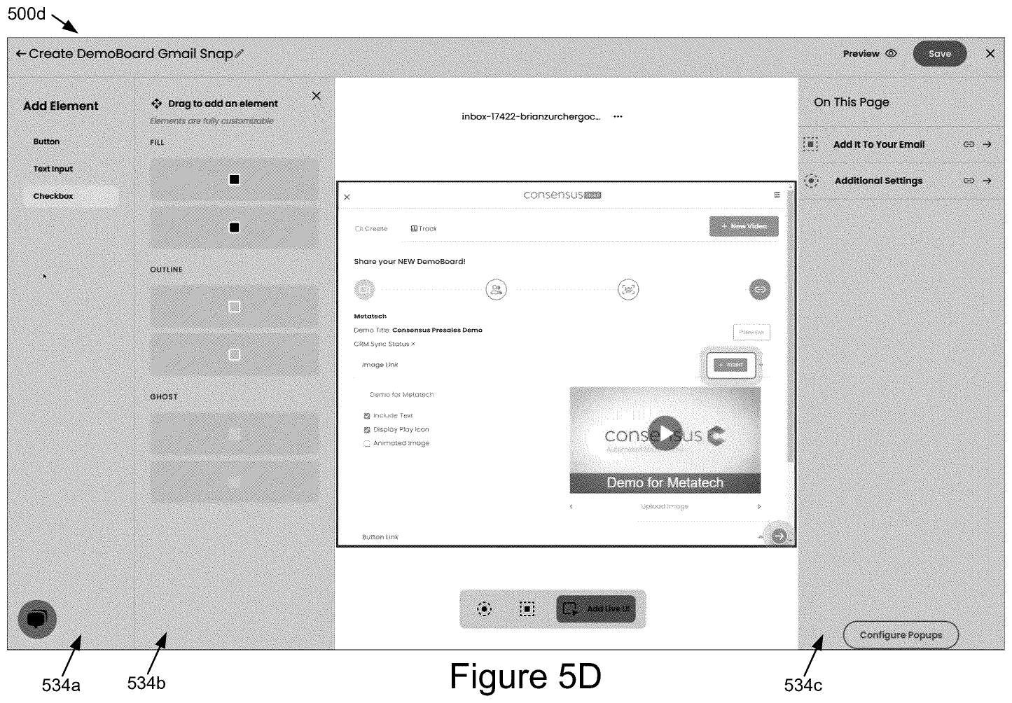

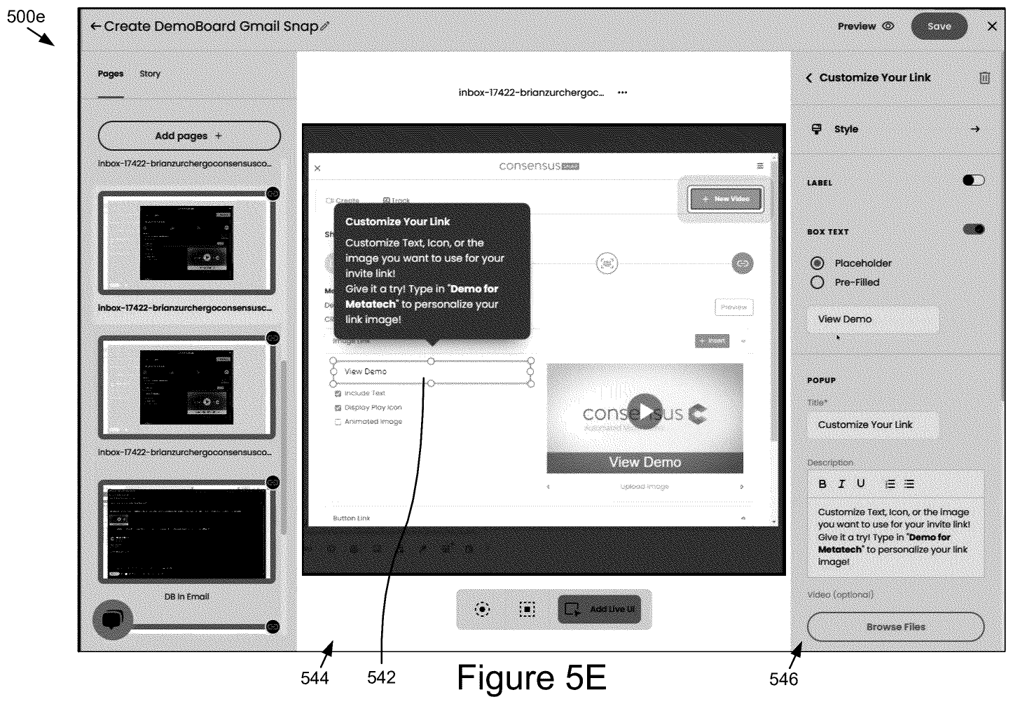

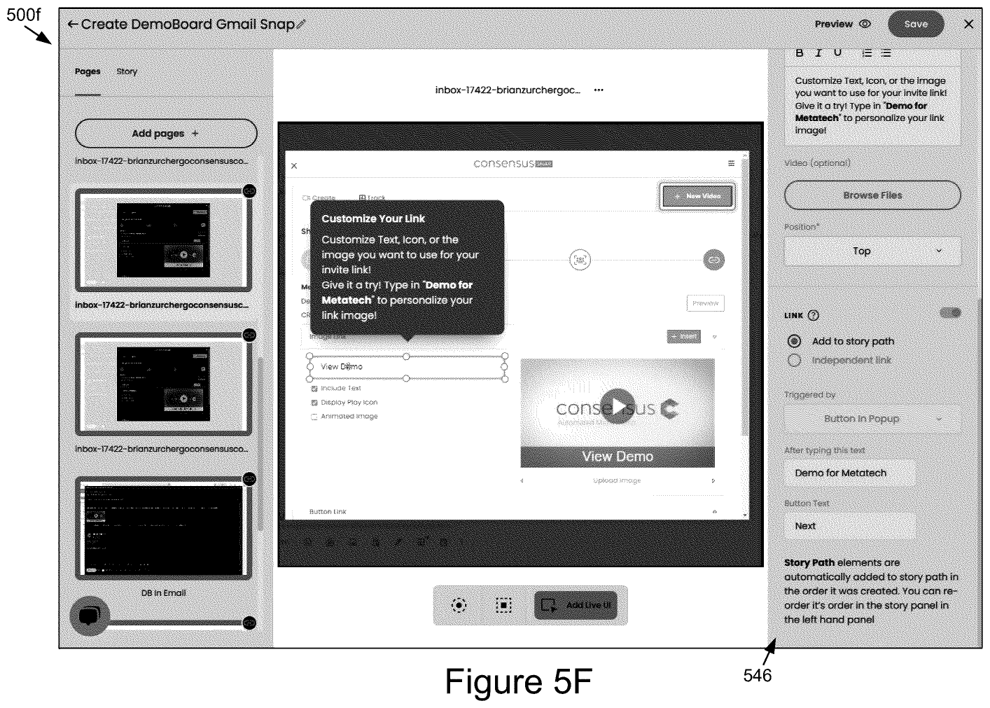

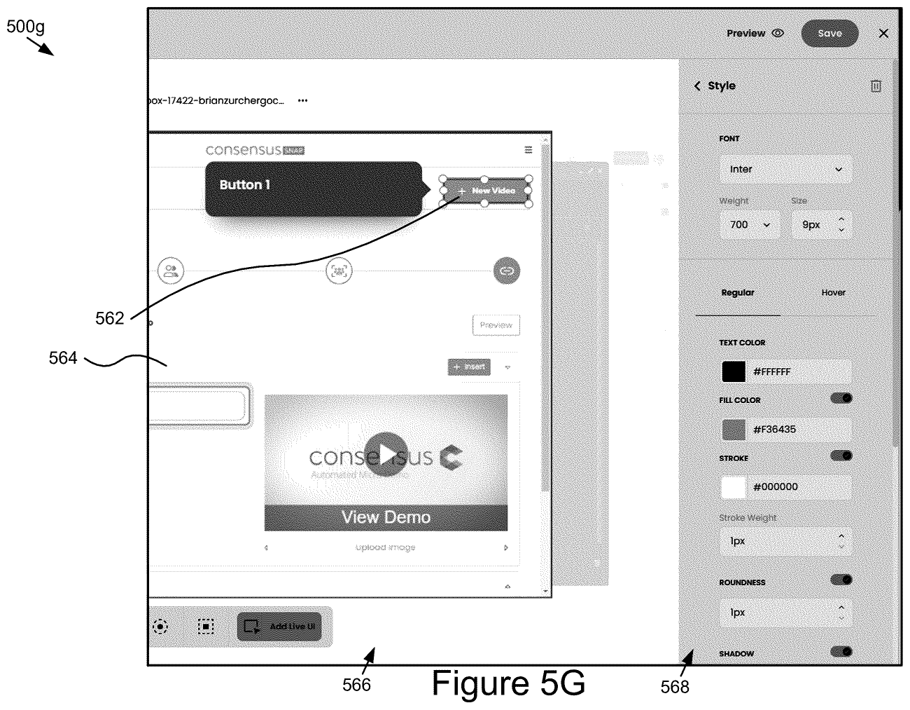

FIG. 5A illustrates an example graphical user interface 500a displayed by a demo application 108 in which a live UI element, such as a hotspot, may be defined and overlayed respective to a location on an image.

As shown in FIG. 5A, the interface 500a may include a preview region 514 illustrating an example demo presentation, for example, for a particular page (e.g., an image with overlayed UI elements). In some implementations, the preview region 514 or other portion of the interface 500b may include an add UI element button 520 that allows various UI elements to be added to a page, demo, or timeline/story of the demo. As illustrated, the add UI element button 520 may allow a spot hotspot, rectangular/boundary hotspot, or other live UI element to be added to the page, for example, as an overlay on a background image.

The interface 500a may also include a navigation bar 516 in which a set or series of pages may be organized into a presentation. For example, the navigation bar 516 may include a graphical panel via which pages/images may be added to a demo, arranged, viewed, deleted, or otherwise interacted with. The pages may be rearranged to change their order (along with the relative orders of UI elements on each page). In some implementations, as noted elsewhere herein, this graphical panel may be modified to show a list of all information regions or other UI elements that are overlayed over the images as a representation of the story path.

The illustrated hotspot 512 includes a circular element that draws attention to a portion of the image (e.g., for a story path step). A circular hotspot, rectangular boundary hot spot, or a live UI element may be selected and defined in both their appearance and behavior when selected or hovered over, for instance. For example, a hotspot may be associated with and overlayed over a defined location on the image. When selected or hovered over, the hotspot may display textual information or media and an element (“next”) that may be selected to move to a next step in a story path.

The interface 500a may also include a configuration panel 518a, which may include various graphical elements for defining attributes of a UI element. For instance, a configuration panel 518a may allow a user to define a style, label, text (e.g., placeholder or pre-filled), a popup title and description, video, a file, other attributes, or other information associated with a UI element. The UI element may also or alternatively have navigation properties, which cause other UI elements and/or other pages in a demo to be displayed, highlighted, navigated to, activated, or otherwise. As illustrated in the example, a position, text, or other attributes of a popup of a hotspot 512 may be configured, along with whether or not (or where) the hotspot falls in a story path or logical flow of the demo presentation.

FIG. 5B illustrates an example graphical user interface 500b in which, similar to FIG. 5A, a hotspot or UI element is defined. In the example of FIG. 5B, the hotspot is a rectangular boundary 522, the size, location, or behavior (e.g., information displayed based on an interaction) of which may be defined, for example, in the configuration panel 518b, which may be displayed along a right side of the interface 500b, although other implementations are possible. As noted elsewhere herein, the size and/or position of a rectangular boundary hotspot (e.g., 522) may be defined by an administrative user. The boundary hotspot may be visible by a user permanently or temporarily, for example, when a demo page is first displayed, when the user is at that point in the story path, or when the user interacts with or hovers over the hotspot. As noted elsewhere herein, the box or its boundary may have various appearances that may be static or animated, depending on the configured attributes.

FIG. 5C illustrates an example graphical user interface 500c in which one or more live UI elements may be added to the image. For instance, FIG. 5C allows buttons to be added and their attributes to be defined (e.g., to define a page as in FIG. 4B). For example, one or more configuration panels 532a, 532b, and 532c may allow buttons, popups, or their attributes, as noted elsewhere herein, to be configured. For example, a first panel 532a may allow a user to define a live UI element type (e.g., button, text input, checkbox, etc.), a second panel 532b may be expanded to define shapes, appearances, etc., of a button or other live UI element, and a third panel 532c may list buttons on a page and/or their configurations or other options.

Similarly, FIG. 5D illustrates an example graphical user interface 500d in which a checkbox live UI element may be defined. Similar to FIG. 5C, the interface 500d allows checkboxes to be added to an image and their attributes to be defined. For example, configuration panels 534a, 534b, and 534c may correspond to 532a, 532b, and 532c, respectively. If a checkbox option is selected in the first panel 534a, then an appearance, shape, etc., may be defined in a second panel 534b. A third graphical panel 534c may list live UI elements and allow a user to configure popups, logic, story flow position, or other attributes of the live UI elements, demo page, or demo presentation, for instance.

Additionally, for instance, similar configuration panels may be used to define a shape, size, or other attribute of a text input section or box. Text input boxes may have various shapes, be opaque or transparent, have a label or no label, have placeholder text or no text, or otherwise. As noted elsewhere herein, other attributes, such as a point in a story path, whether in the story path or independent, etc., may be defined. For ease of configuration, in some instances, the buttons, text input boxes, checkboxes, or other live UI elements (e.g., in the panels 532b or 534b) may be dragged onto the image. Once they are on the image, they may be further configured, resized, or their positions in a story path redefined. Depending on the implementation, non-independent UI elements may automatically be added to a story path in the order in which they are added.

FIG. 5E illustrates an example graphical user interface 500e in which a live UI element, such as a link button 542, is defined. The link button 542 may be configured with text, a label, a popup, popup title, description, video, or other attributes. The link button 542, when clicked may direct the user to another location in the demo presentation, to a certain page, or to another UI element.

In some implementations, a UI element, such as the link button 542 or another element, may be a text input field, which may have a boundary. A boundary for the field may be defined relative to a selected image, and other attributes may be defined. For example, a style, whether the field is pre-filled or receives text, a title, description (e.g., displayed when the field is selected), link to media, or other details, as illustrated elsewhere, may be defined.

A boundary for the field may be defined relative to a selected image, and other attributes may be defined. For example, a style, whether the field is pre-filled or receives text, a title, description (e.g., displayed when the field is selected), link to media, or other details, as illustrated elsewhere, may be defined. As shown in FIG. 5E, the interface 500e may include a preview region 544 illustrating an example demo presentation, for example, for a particular page (e.g., a captured image with overlayed UI elements).

The boundary may be a box that is positioned on top of an image, and which may block out portions of the image and which may be illustrated in the preview region 544. In some instances, in production, the boundary may also be highlighted, colored, or otherwise emphasized to indicate to the user a portion of the demo with which the user may interact. In some implementations, a user may define a location or boundary of a UI element in the preview region 544. Other navigation and configuration panels may also be displayed. For example, FIG. 5E may include a configuration bar/panel 546, which these attributes of the link, text field, or other type of UI element may be configured.

FIG. 5F illustrates an example graphical user interface 500f, which may correspond to the example graphical user interface 500e in which the configuration bar 546 is scrolled down to show further options for defining the UI element, for example, to define whether the UI element is in the story path or is independent. As shown in the example, the configuration bar 546 may define a position for the UI element, whether the UI element is inside of or independent of a story path of a demo, how the UI element may be triggered (by a previous UI element, display of a page, by a button in a popup, or other trigger), what happens after interaction with the UI element, or other details. As an example, for a story path of a demo presentation, pages or UI elements within the story path may be automatically added to a sequence of steps in the order in which the live UI element was created, though it can be re-ordered in the story panel/navigation bar 546. For example, where the UI element is a text input field, a style, whether the field is pre-filled or receives text, a title, description (e.g., displayed when the field is selected), link to media, or other details, as illustrated elsewhere, may be defined.

In some cases, a UI element may have logic, for example, where it includes a button, drop down menu, or allows multiple different text inputs, and the configuration panel 546 may allow the logic and interaction between UI elements to be defined.

FIG. 5G illustrates a portion of an example graphical user interface 500g in which a style of a live UI element may be defined. As illustrated, a button 562 may be defined and overlayed over an image 564 in a preview region 566. In some implementations, the preview region 566 may render the image as an overlay over another window or graphical element.

The example interface 500g also depicts a configuration bar/panel 568 that includes various elements for defining the style of a button, although it may alternatively be used to define attributes of a demo page or other aspect of a demo presentation. For example, a fill color, font, text color, opacity, position, size, icon, roundness, shadow, etc., of a button may be defined. In some implementations, the demo application 108 may receive an uploaded font that may be used in a UI element.

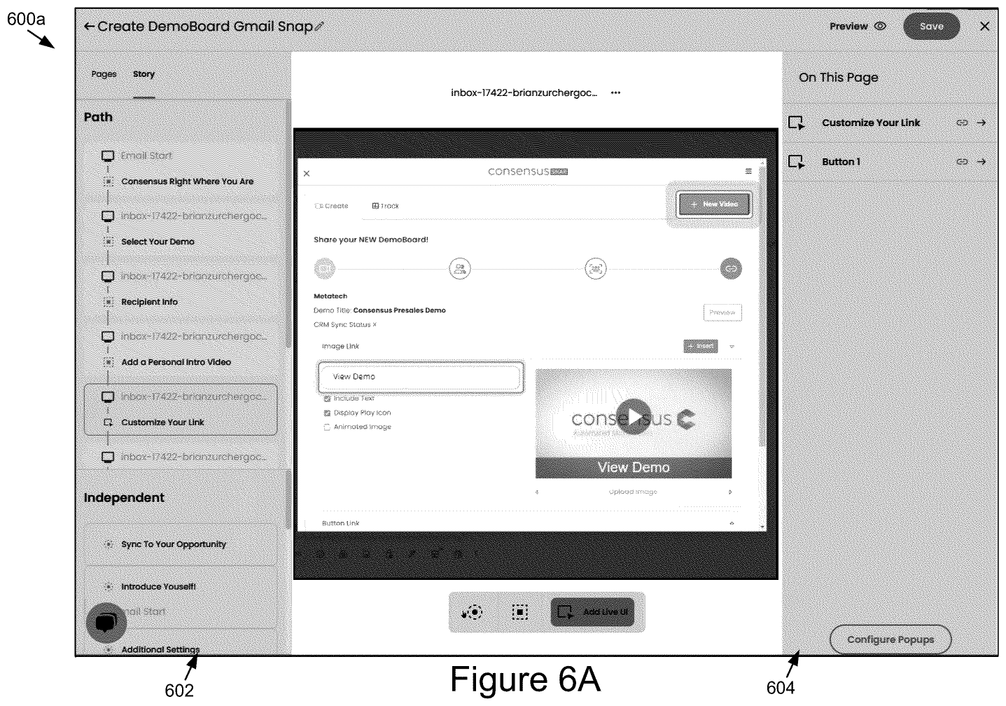

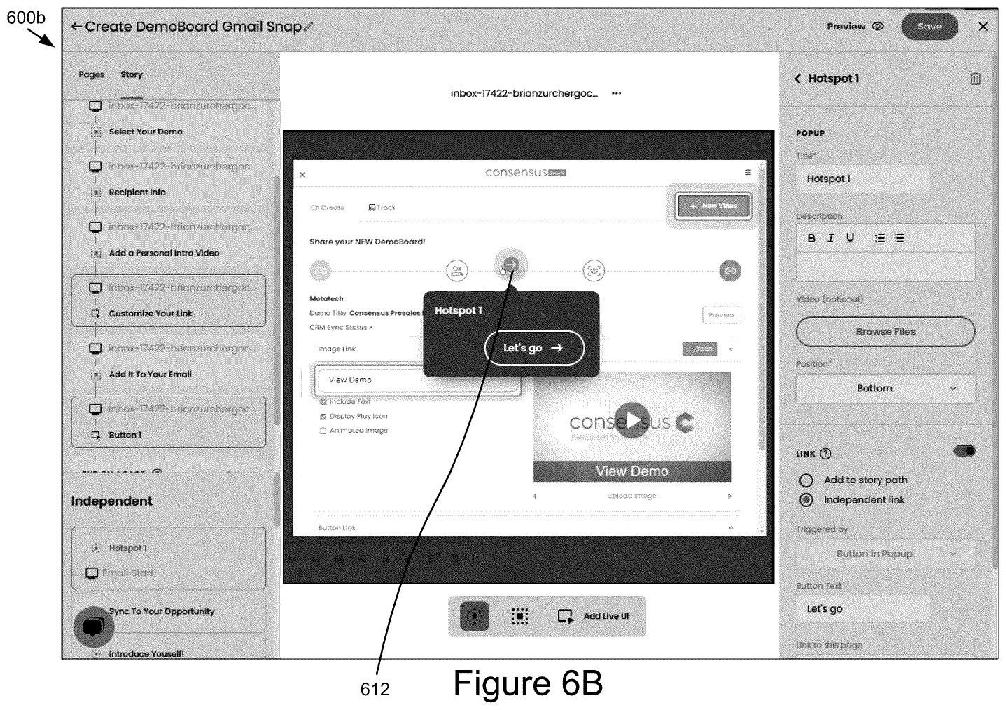

FIG. 6A illustrates an example graphical user interface 600a in which a story path is graphically represented on a side panel 602, which may correspond to the navigation panel noted elsewhere herein (e.g., 516 in FIG. 5A). For example, a story path with pages, UI elements, etc., may be displayed and/or edited in addition to or in place of a set of demo pages. For instance, the images, UI elements, and other data may be displayed for a selected page or for the entire demo. Independent elements, which may be UI elements, pages, etc., not automatically displayed or linked within the story path, may also be displayed.

In some cases, a second graphical panel 604 may display specifically those UI elements on the displayed demo page, and they may be used to reorder or redefine the UI elements. For example, where the UI elements are or include buttons, links, or popups, the buttons, links, or popups may be defined.

FIG. 6B illustrates an example graphical user interface 600b in which a hotspot 612 is defined within the context of a story path. A hotspot 612, for example, may be an element (visible or not) overlayed on a demo page which may be selected or hovered over to display a popup, which may have information or other buttons, logic, etc. For instance, an attribute of the hotspot 612 indicating whether the hotspot 612 is in the story path or is independent from the path may be manually defined by an administrator (e.g., a user having a role or account for creating a demo). As noted above, where UI elements are added to the story path, they may be automatically added in the order in which they are created, but they may be reordered.

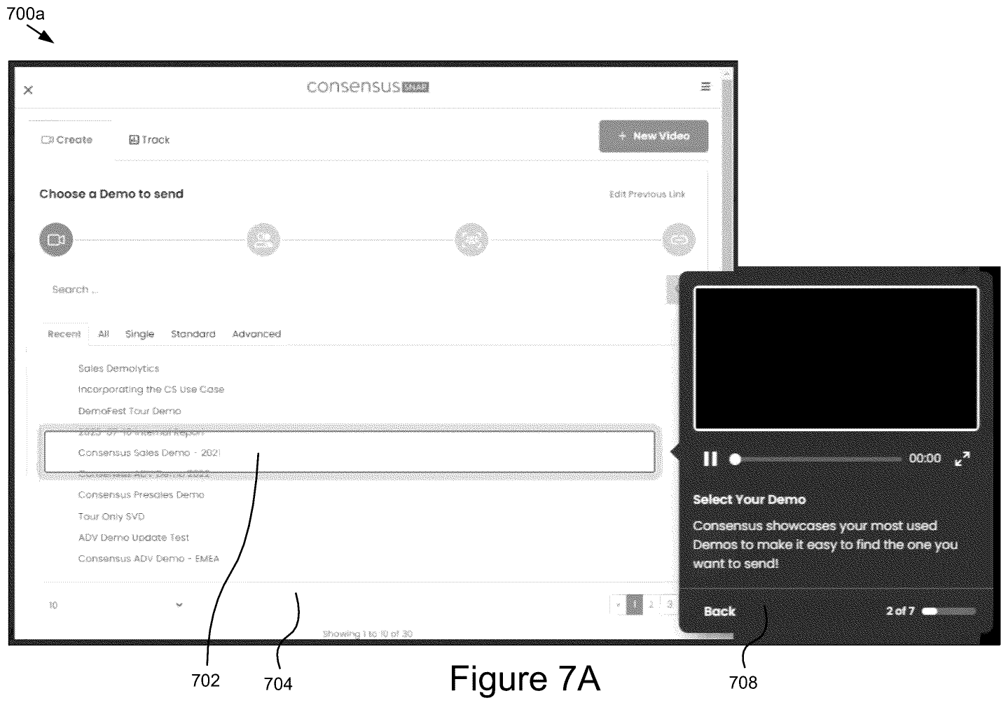

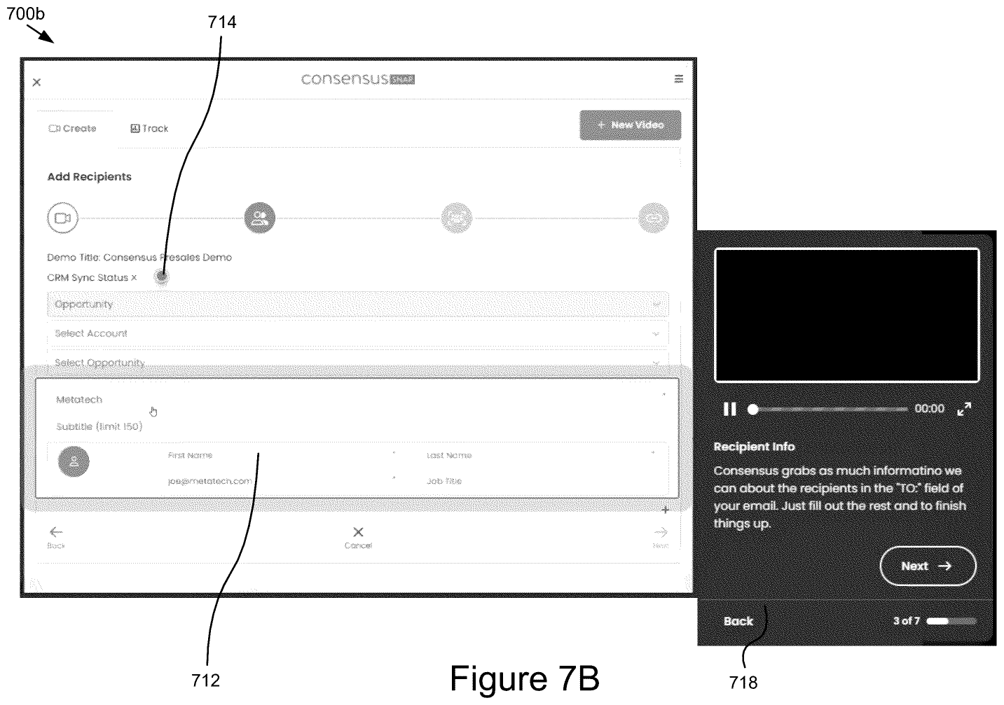

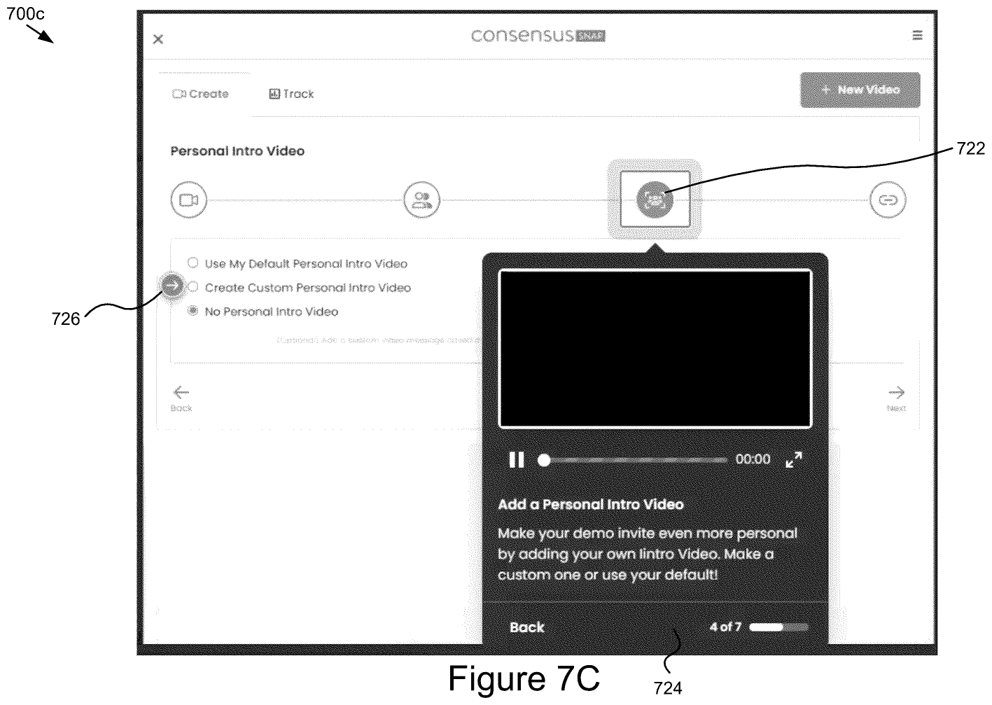

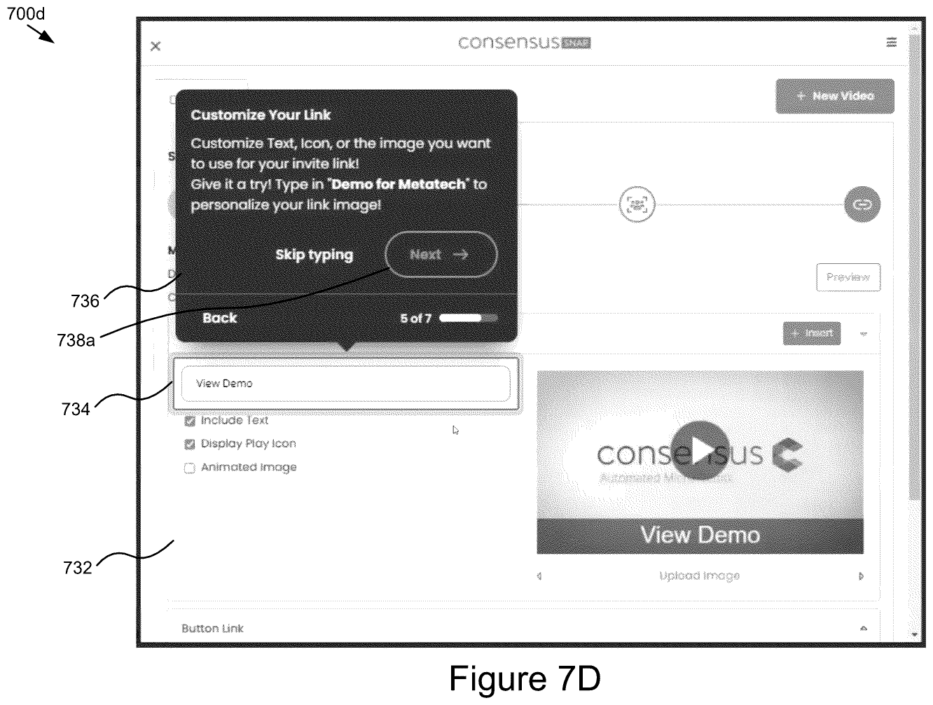

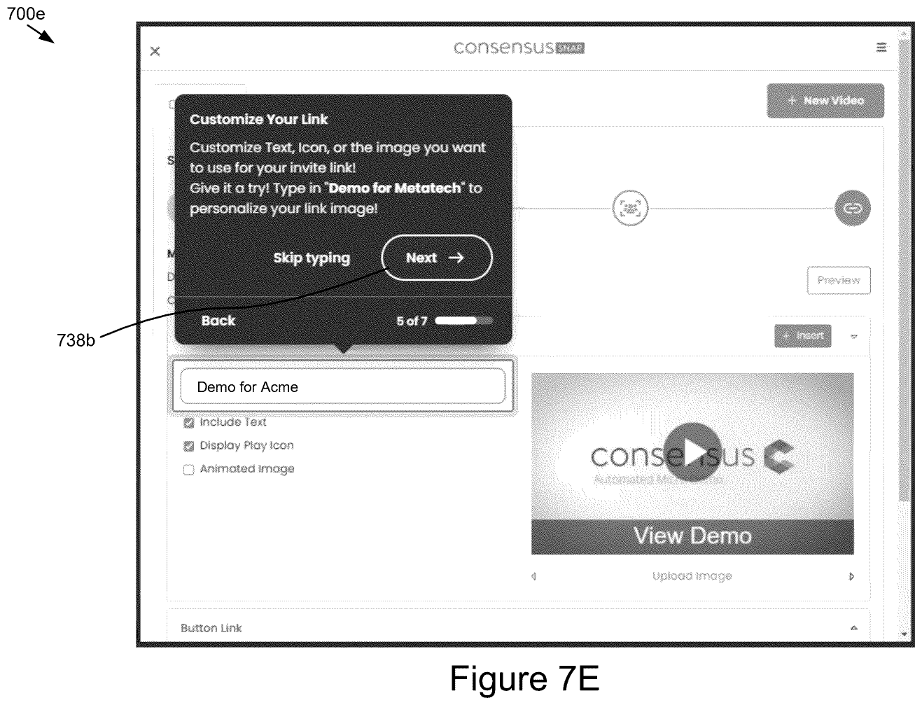

FIG. 7A illustrates an example graphical user interface 700a in which a demo is displayed to a user. In the example, a rectangular hotspot/UI element 702 is shown highlighting an area on the background image 704. When the hotspot 702 is selected (e.g., clicked, hovered over, or automatically selected based on a sequence of steps in the story path), a popup 708 showing a title, description and other information may be displayed on the interface 700a. For example, the popup 708 may include a video, a navigation element showing or allowing navigation backward or forward in the story path may be shown. Similarly, in some instances, the popup 708 may show a current position in percentage or step number of the UI element and/or demo page in the story path or on the demo page.

The interface 700a may include one or more images (e.g., 704) with one or more live UI elements (e.g., 702) overlayed thereon and/or one or more popups (e.g., 708). In come implementations, these and/or other graphical elements may be overlayed on a computer display, for example, as windows, frames, or overlays over the display. In the example, a user may have received a link to a demo presentation in an email. In some implementations, the demo application 108 may display the interface 700a.

FIG. 7B illustrates an example graphical user interface 700b in which a next step is shown in the demo, for example, the interface 700b may be displayed in response to selecting “next” or another graphical element (e.g., a UI element) in the interface 700a. The interface 700b may completely replace interface 700a, for example. A popup 718 (e.g., including text, media, a position indicator, a “next” or “back” button, etc.) may automatically be displayed as a next step in the story path or it may be displayed when a user selects or hovers over a hotspot area 712, depending on the configuration. An additional hotspot 714 UI element that is independent of the story path is also shown and may be selected by a user to display other information, such as a popup or otherwise, as noted elsewhere herein.

FIG. 7C illustrates an example graphical user interface 700c in which a next step is shown in the story path, for example, after the step illustrated in FIG. 7B. The step of FIG. 7C may be displayable (e.g., by selecting next in the popup 718 of FIG. 7B) or automatically displayed based on completion of a previous step. In other implementations, the user may deviate from a defined story path to review components having greater interest to the user. As illustrated in the example, a hotspot 722 is selected, which displays a popup 724 including a media segment (e.g., referencing an online, integrated, or locally stored media file), textual information, progress information, and navigational buttons are displayed. An additional, independent hotspot 726 is also displayed, with which the user may interact to display other elements or cause other effects in the demo, such as changing a page, for instance, with a different background image and/or different UI elements, so that it appears as though the user is interacting with the demoed application or website, for example.

FIG. 7D illustrates an example graphical user interface 700d in which an example next step in a story path is displayed, for example, after the step depicted in FIG. 7C. For example, the next step in the path may be on a different image 732 than the previous image (e.g., in FIG. 7C) and may be automatically displayed based on completion of a previous step and/or based on interaction with a UI element. In the depicted example, the live UI element 734 may be a link, hotspot box, text-input field, or button (e.g., illustrated by a highlighted boundary box) and may include a popup 736 displayed based on interaction with the UI element 734 or displayed automatically. The popup 736 may provide instructions or other information for the UI element 734 or underlying feature represented in the image 732.

For example, as illustrated in FIG. 7D, where a text input live UI element 734 overlays over a portion of the image (e.g., where a text-input field would have been located in the original application). The text-input field may display text and/or receive text. For example, the popup instructs the user to enter defined text (e.g., “Demo for Acme”) into the field. In response to receiving the defined text, the demo application 108 may update the field (e.g., to include the typed text), mark the step as complete, and allow movement to a next step in the story path. For example, in FIG. 7D, a “next” button 738a in the popup 736 is grayed out; however, in the example interface 700e of FIG. 7E, the “next” button 738b is updated to allow navigation forward in the story path.

It should be noted that other operations, orders, and features are contemplated herein. For instance, the technology may use fewer, additional, or different operations or orders of operations than those described herein without departing from the scope of this disclosure. It should be noted that although the operations of the methods and interfaces are described in reference to the demo application 108, they may be performed by different components of the system 100, distributed, or otherwise modified without departing from the scope of this disclosure. Furthermore, while the example interfaces illustrated and described in FIGS. 4A-7E may be generated and provided for display on client devices 106 by a demo application 108, they may be provided by other devices. For instance, an administrative user may configure a demo presentation on a demo application 108 and then send the demo presentation to an end user. The demo presentation may be provided on a web browser and fully or partially executed thereon, for example, as HTML, JavaScript, CSS, or other code, or the demo may otherwise be provided, for example by a web server (e.g., 124), although other implementations are possible and contemplated herein.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats.

Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
determining, by one or more processors, a first image for a demonstration presentation, the demonstration presentation including a plurality of pages demonstrating a digital product;
setting, by the one or more processors, the first image as a background of a first page of the plurality of pages of the demonstration presentation;
determining, by the one or more processors, a location on the first image for displaying one or more user interface (UI) elements;
storing, by the one or more processors, the demonstration presentation including the one or more UI elements on the first image in a computer-accessible data storage device; and
providing, by the one or more processors, the stored demonstration presentation including providing the first image and the one or more UI elements.

2. The computer-implemented method of claim 1, further comprising:
determining, by the one or more processors, a type of a first UI element selected from the group consisting of a checkmark, a hotspot, a button, and a text-input field; and
determining, by the one or more processors, a first location relative to the first image for the first UI element of the determined type.

3. The computer-implemented method of claim 1, further comprising:
providing, by the one or more processors, a graphical user interface including a preview region showing the first image and a side panel showing a first representation of a first UI element;
receiving, by the one or more processors, a user input dragging the first representation of the first UI element onto the first image in the preview region; and
associating, by the one or more processors, the location to which the first representation was dragged with an overlayed location of the first UI element on the first image for the demonstration presentation.

4. The computer-implemented method of claim 1, wherein:
a first UI element of the one or more UI elements is overlayed over a defined location on the first image, the first UI element replicating a functionality of the digital product in the demonstration presentation.

5. The computer-implemented method of claim 4, wherein:
the first UI element includes a hyper-text transfer language (HTML) element overlayed over the first image, the first image being a static digital image, the HTML element providing the replicated functionality.

6. The computer-implemented method of claim 4, wherein:
providing access to the stored demonstration presentation includes receiving a user interaction with the first UI element and, responsive to the user interaction, displaying an informational popup, the informational popup showing information respective to the functionality of the digital product.

7. The computer-implemented method of claim 1, wherein:
providing the stored demonstration presentation includes providing a graphical user interface showing the plurality of pages with a plurality of UI elements, the plurality of UI elements being organized into a defined sequence of steps, the sequence of steps controlling when each of the plurality of UI elements and each of the plurality of pages are displayed on a client device.

8. The computer-implemented method of claim 1, further comprising:
determining, by the one or more processors, one or more attributes of the one or more UI elements, the one or more attributes including whether the one or more UI elements are displayed within a defined sequence of steps or displayed independently from the defined sequence of steps of the demonstration presentation.

9. The computer-implemented method of claim 1, wherein:
the demonstration presentation includes the plurality of pages demonstrating the digital product, each of the plurality of pages including an image as a background and a UI element, the UI elements of the plurality of pages being organized into a defined story path with a sequence of steps, an interaction with a first step causing the one or more processors to display a subsequent step in the sequence of steps, the first step and the subsequent step each including a UI element of the one or more UI elements.

10. The computer-implemented method of claim 1, wherein:
the first image includes a captured screenshot of a webpage, the webpage including functionality that is executable from the captured screenshot, the one or more UI elements replicating the functionality of the webpage in the demonstration presentation.

11. A system comprising:
one or more processors; and
a memory storing instructions that, when executed by the one or more processors, cause the system to perform operations comprising:
determining a first image for a demonstration presentation, the demonstration presentation including a plurality of pages demonstrating a digital product;
setting the first image as a background of a first page of the plurality of pages of the demonstration presentation;
determining a location on the first image for displaying one or more user interface (UI) elements;
storing the demonstration presentation including the one or more UI elements on the first image in a computer-accessible data storage device; and
providing the stored demonstration presentation including providing the first image and the one or more UI elements.

12. The system of claim 11, wherein the operations further comprise:
determining a type of a first UI element selected from the group consisting of a checkmark, a hotspot, a button, and a text-input field; and
determining a first location relative to the first image for the first UI element of the determined type.

13. The system of claim 11, wherein the operations further comprise:
providing a graphical user interface including a preview region showing the first image and a side panel showing a first representation of a first UI element;
receiving a user input dragging the first representation of the first UI element onto the first image in the preview region; and
associating the location to which the first representation was dragged with an overlayed location of the first UI element on the first image for the demonstration presentation.

14. The system of claim 11, wherein:
a first UI element of the one or more UI elements is overlayed over a defined location on the first image, the first UI element replicating a functionality of the digital product in the demonstration presentation.

15. The system of claim 14, wherein:
the first UI element includes a hyper-text transfer language (HTML) element overlayed over the first image, the first image being a static digital image, the HTML element providing the replicated functionality.

16. The system of claim 14, wherein:
providing access to the stored demonstration presentation includes receiving a user interaction with the first UI element and, responsive to the user interaction, displaying an informational popup, the informational popup showing information respective to the functionality of the digital product.

17. The system of claim 11, wherein:
providing the stored demonstration presentation includes providing a graphical user interface showing the plurality of pages with a plurality of UI elements, the plurality of UI elements being organized into a defined sequence of steps, the sequence of steps controlling when each of the plurality of UI elements and each of the plurality of pages are displayed on a client device.

18. The system of claim 11, wherein the operations further comprise:
determining one or more attributes of the one or more UI elements, the one or more attributes including whether the one or more UI elements are displayed within a defined sequence of steps or displayed independently from the defined sequence of steps of the demonstration presentation.

19. The system of claim 11, wherein:
the demonstration presentation includes the plurality of pages demonstrating the digital product, each of the plurality of pages including an image as a background and a UI element, the UI elements of the plurality of pages being organized into a defined story path with a sequence of steps, an interaction with a first step causing the one or more processors to display a subsequent step in the sequence of steps, the first step and the subsequent step each including a UI element of the one or more UI elements.

20. The system of claim 11, wherein:
the first image includes a captured screenshot of a webpage, the webpage including functionality that is executable from the captured screenshot, the one or more UI elements replicating the functionality of the webpage in the demonstration presentation.
